(19) United States
(12) Patent Application Publication
(10) Pub. No.: US 2006/0267303 A1
(43) Pub. Date: Nov. 30, 2006

(54) Collapsible supporting structure

(76) Inventor: Matthew Golias, Victoria (AU)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/450,036

(22) Filed: Jun. 8, 2006

Related U.S. Application Data
(63) Continuation-in-part of application No. 10/554,686.

(30) Foreign Application Priority Data
Apr. 30, 2003 (AU) 2003902058
Jun. 9, 2005 (AU) 2005903019

(51) Int. Cl. B62B 3/00

(52) U.S. Cl. 280/47.34

(57) ABSTRACT

A collapsible supporting structure has a mounting body, arms extending upwardly from the mounting body and front and rear wheeled support legs. At least some of the front and rear legs and arms are pivotally mounted to the mounting body to enable pivoting about the mounting body about respective transverse axes between an operative configuration and a collapsed configuration. In the collapsed configuration, the front and rear legs and arms extend substantially coextensively. The arms have an extended configuration for use and also a retracted configuration which results in a reduction of the overall length of the arms. In the retracted configuration, the length of the arms approximates that of either of the front or rear legs.

### CROSS-REFERENCE TO RELATED APPLICATIONS

This application is a continuation-in-part of U.S. patent application Ser. No. 10/554,686, filed Oct. 27, 2005, which is a United States Nationalization of PCT International Application No. PCT/AU2003/001025, filed Aug. 13, 2003, which claims priority to Australian Application No. 2003902058, filed Apr. 30, 2003, which applications are incorporated herein by specific reference.

### BACKGROUND OF THE INVENTION

1. The Field of the Invention

The present invention relates generally to collapsible supporting structures for bearing loads, and in particular to collapsible supporting structures capable of adopting an operative configuration and a second transportable configuration to allow for ready transportation of the supporting structure. The invention is suitable for use in structures such as strollers, pushchairs and related nursery products, and will be convenient to describe the invention in relation to that exemplary application. It is to be understood however that the invention is not limited to use in relation to these applications only and may also have application for golf buggies, and shopping trolleys and other push carriers.

2. The Relevant Technology

A number of attempts have been made to provide strollers or pushchairs that can be placed into a collapsed configuration to enable convenient transportation or storage. Collapsible strollers are typically formed by a number of members which are mutually interconnected by means of slidable fittings, so that as the stroller is collapsed, the frame members slide through the slidable fittings. Other members of conventional strollers must be detached from each other before the stroller can adopt the collapsed configuration, thus making the strollers cumbersome to assemble and use. Moreover, such strollers are frequently incapable of adopting a genuinely collapsed position which significantly reduces the volume occupied by the stroller. Conventional strollers are also frequently large and heavy and not adapted to the needs of a modern lifestyle in which strollers are frequently required to be transported in cars, airplanes or other transportation means.

It would therefore be desirable to provide a collapsible supporting structure for use in applications such as strollers or pushchairs that is structurally simple, lightweight and relatively inexpensive to manufacture. It would also be desirable to provide a collapsible supporting structure that is simple to manipulate between a collapsed configuration and a load supporting configuration, and is convenient to transport or store when in the collapsed configuration. It would also be desirable to provide a collapsible supporting structure that ameliorates or overcomes one or more of problems or inconveniences of known collapsible supporting structures.

### SUMMARY OF THE INVENTION

In accordance with a first aspect of the invention, there is provided a collapsible supporting structure having: a mounting body;
arms extending upwardly from the mounting body; and
front and rear wheeled support legs, wherein at least some of the front and rear legs and arms are pivotally mounted to the mounting body to enable pivoting about the mounting body such that each point on said some of the front and rear legs and arms moves in a fore-aft upright plane between an operative configuration and a collapsed configuration in which the front and rear legs and arms extend substantially coextensively,
wherein the arms have an extended configuration for use and a retracted configuration which results in a reduction of the overall length of the arms such that in the retracted configuration, the length of the arms approximates that of either of the front or rear legs.

The arms may be foldable. Alternatively, they may be telescopic. Preferably, the arms fold approximately midway along their length.

In a preferred form of the invention, the arms are pivotable about the mounting body and a locking arrangement is provided to maintain the arms in the operative and unfolded configuration, a release actuator being further provided for simultaneous release of the arms from the operative and unfolded configuration to enable simultaneous pivoting and folding.

In a most preferred form of the invention, there are one or more rear legs and the one or more rear legs and the arms are pivotable about the mounting body whilst the front legs are fixed to the mounting body. Preferably, there are two rear legs, each mounted to the mounting body by a leg connection arrangement which includes a locking arrangement to secure the rear legs in the operative configuration. The locking arrangements may be interconnected for simultaneous release by the operator. Preferably, the one or more rear legs are pivotable in a first rotational direction and the arms are pivotable in a second opposite rotational direction.

The mounting body may include a transversely extending mounting bar having a central transverse axis. Preferably, the one or more rear legs are mounted for rotation about the mounting body about a first transversely extending axis and the arms are mounted for rotation about the mounting body about a second transversely extending axis. The first and second axes are preferably parallel to each other and offset from the central axis of the mounting bar.

In accordance with a second aspect of the present invention, there is provided a collapsible supporting structure having:
a mounting body;
arms extending upwardly from the mounting body; and
front and rear wheeled support legs, wherein at least some of the front and rear legs and arms are pivotally mounted to the mounting body to enable pivoting about the mounting body such that each point on said some of the front and rear legs and arms moves in a fore-aft upright plane between an operative configuration and a collapsed configuration in which the front and rear legs and arms extend substantially coextensively,
wherein the arms are foldable such that in the folded configuration the resultant length of the arms approximates that of either of the front or rear legs.

In accordance with a third aspect of the present invention, there is provided a collapsible supporting structure having:
a mounting body;
arms extending upwardly from the mounting body; and
front and rear wheeled support legs, wherein at least some of the front and rear legs and arms are pivotally mounted to the mounting body to enable pivoting about the mounting body about respective transverse axes between an operative configuration and a collapsed configuration in which the front and rear legs and arms extend substantially coextensively,
wherein the arms have an extended configuration for use and a retracted configuration which results in a reduction of the overall length of the arms such that in the retracted configuration, the length of the arms approximates that of either of the front or rear legs.

In accordance with a fourth aspect of the present invention, there is provided a collapsible supporting structure having:
a mounting body;
arms extending upwardly from the mounting body; and
front and rear wheeled support legs, wherein at least some of the front and rear legs and arms are pivotally mounted to the mounting body to enable pivoting about the mounting body about respective transverse axes between an operative configuration and a collapsed configuration in which the front and rear legs and arms extend substantially coextensively,
wherein the arms are foldable approximately midway along their length.

### BRIEF DESCRIPTION OF THE DRAWINGS

The following description refers in more detail to the various features of the collapsible supporting structure of the present invention. To facilitate an understanding of the invention, reference is made in the description to the accompanying drawings where the collapsible supporting structure is illustrated in a preferred embodiment. It is to be understood however that the invention is not limited to the preferred embodiment illustrated in the drawings.

In order that the invention can be more readily understood an embodiment will be described by way of illustration only with reference to the drawings wherein:

FIG. 1 is a perspective view of a collapsible supporting structure in an open configuration in accordance with a first embodiment of the invention;

FIG. 2 is a side elevation of the collapsible supporting structure of FIG. 1;

FIG. 3 is a front elevation of the collapsible supporting structure of FIG. 1;

FIG. 4 is a perspective view of a collapsible supporting structure in a closed collapsed configuration in accordance with the first embodiment of the invention of FIG. 1;

FIG. 5 is a side elevation of the collapsible supporting structure in the closed collapsed configuration of FIG. 4;

FIG. 6 is an overhead plan view of the collapsible supporting structure in the closed collapsed configuration of FIG. 1;

FIGS. 7.1, 7.2, 7.3 and 7.4 are vertical cross sections of part of the collapsible supporting structure of FIG. 1 around the mounting body in various stages of operation of collapsing mechanism;

FIGS. 8, 9 and 10 are schematic views of other embodiments of a collapsible supporting structure in accordance with a different aspect of the invention with different folding arrangements that do not require a rotation mechanism.

FIGS. 11 to 15 are respectively front perspective, rear perspective, front, rear and plan views of a collapsible supporting structure in accordance with the embodiment of FIG. 10;

FIG. 16 is an exploded partial view of the mounting body and elements connected thereto forming part of the collapsible supporting structure shown in FIGS. 11 to 15;

FIG. 17 is a partial exploded view of a leg connection arrangement for connecting a support leg assembly to the mounting body in the collapsible supporting structure shown in FIGS. 11 to 15;

FIG. 18 is an exploded view of a linked brake assembly forming part of the collapsible supporting structures of FIGS. 11 to 15;

FIG. 19 is an exploded view of a frame connection arrangement for connecting a support frame to the mounting body of the collapsible supporting structure shown in FIGS. 11 to 15;

FIGS. 20 to 22 show the collapsible supporting structure of FIGS. 11 to 15 illustrating the transition of the supporting structure from a load bearing configuration to a collapsible configuration; and

FIGS. 23 and 24 are respectively plan and side views of the collapsible supporting structure of FIGS. 11 to 15 in a collapsed configuration.

### DETAILED DESCRIPTION OF THE PREFERRED EMBODIMENTS

Referring to the drawings there is shown a collapsible supporting structure in the form of a stroller or push chair 11.

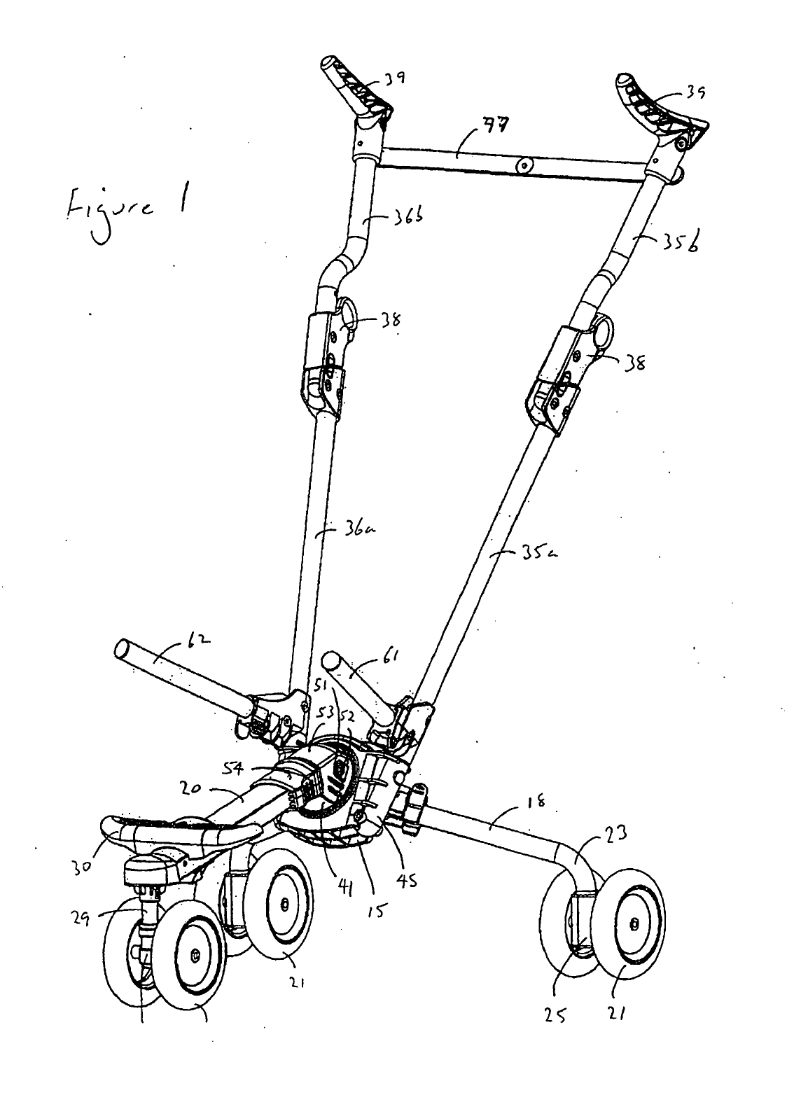

The structure includes a mounting body 15 and two rear elongated support legs 18 and 19 and a front support leg 20. The support legs are pivotally connected to and extend from the mounting body 15 in substantially equiangular arrangement with ground engaging wheels 21 attached to each respective distal end. The arrangement of the rear support legs 18 and 19 in the supporting position as shown in FIG. 1 is in a splayed arrangement from the rear of the mounting body 15 with the front support leg extending directly forwards of the mounting body 15. The two rear supporting legs 18, 19 extend at symmetrically opposing angles from the rear of the mounting block 15 such that the three legs provide a tripod-like support of a load. The rear support legs extend outwardly and partly downwardly in a linear arrangement to a curved knee 23 having a cylindrical substantially vertical lower leg 24. A sleeve 25 fixedly mounted between two parallel ground engaging wheels 21 captures the end of the lower leg 24 while allowing swiveling movement of the wheels around the lower leg. The front support leg 20 has a planar cruciform shape with the base of the cross being pivotally connected to the mounting body 15. At the distal end are mounted two adjacent parallel ground engaging wheels 21 on a swiveling mount 28 on a cylindrical wheel post 29 extending from an underneath portion of the support leg 20. The cross member forming the cruciform shape is on an upper surface and acts as a footrest 30.

The mounting body 15 is a substantially paralleliped block having substantially parallel planar front and back surfaces with height and width greater than the depth and with opposing outwardly curved top and bottom sides. The internal structure of the mounting body is honeycombed to provide a strength that is suitable to form the supporting central body that can receive weight from structures mounted thereon and stably pass the weight to the supporting legs and the ground engaging wheels.

The mounting of the support legs 18, 19, 20 to the mounting body 15 are by connection means which have two operative systems. The first operative system of the connection means is a rotation means. The second operative system is a pivotal system.

The rotation means includes a rotating cylindrical disc 41 mounted in the centre of the mounting body 15 and having planar circular front and back faces that are substantially coplanar with the front and back respectively of the mounting body 15. The rotating disc 41 is able to rotate therein around an axis that is normal to the front surface of the rotating disc and mounting block.

An end of each of the support legs 18, 19 and 20 are connected to the rotating disc 41 allowing rotation of each support leg. At least one of the support legs is mounted on each side of the disc of the mounting body allowing for rotation of the attached support legs at the same time. The disc has two parts each with an outside surface and an interconnecting part. The rotation means is mounted in a cavity in the mounting body with the two interconnecting parts engaging each other within the cavity and the two outside surfaces being visible from the outside of the mounting body and able to have support legs attached thereon.

The rotation means enabling simultaneous rotation of legs on either side of the mounting body. The rotation means can include locking means to selectively allow simultaneous rotation or separate rotation or independent rotation.

The second operative system being a pivotal system includes a pivoting means made integral with the connection of the support legs 18, 19 and 20 to the rotating disc 41. This pivoting means for the front support leg 20 comprises a U-shaped pivot guard bracket that has the flat central part attached to the front surface of the rotating disc 41. A pivot pin 52 extends between the sides of the U shaped pivot guard bracket and connect through the base end of the cruciform shaped front support leg 20 to allow pivoting movement thereof. The pivot guard performs further function of limiting sideways flex of the front support leg 20 and still further includes a limiting shoulder piece 53 to limit the amount of pivot of the support leg 20 in one direction relative to the mounting body 15. In this way the pivoting means allows the support leg to pivot to the required splayed supporting position while allowing the support leg to move in towards the mounting body.

The supported structure which is to be supported by the mounting body 15 and the support legs 18, 19 and 20 and wheels 21 are based on upwardly extending arms 35 and 36 mounted on the mounting body. The mounting body 15 apart from having the central rotating disc 41 has side sheaths 45 and 46 on either side of the mounting body which have substantially the same height and depth as the mounting body 15. The internal cavities of the side sheaths are substantially V shaped with a pivot pin near the bottom to connect with and pivotally hold the base of the upright elongated arms 35 an 36 so that the upright arms can pivot from a position alongside one side of the V-shape to a position alongside the other side of the V-shape.

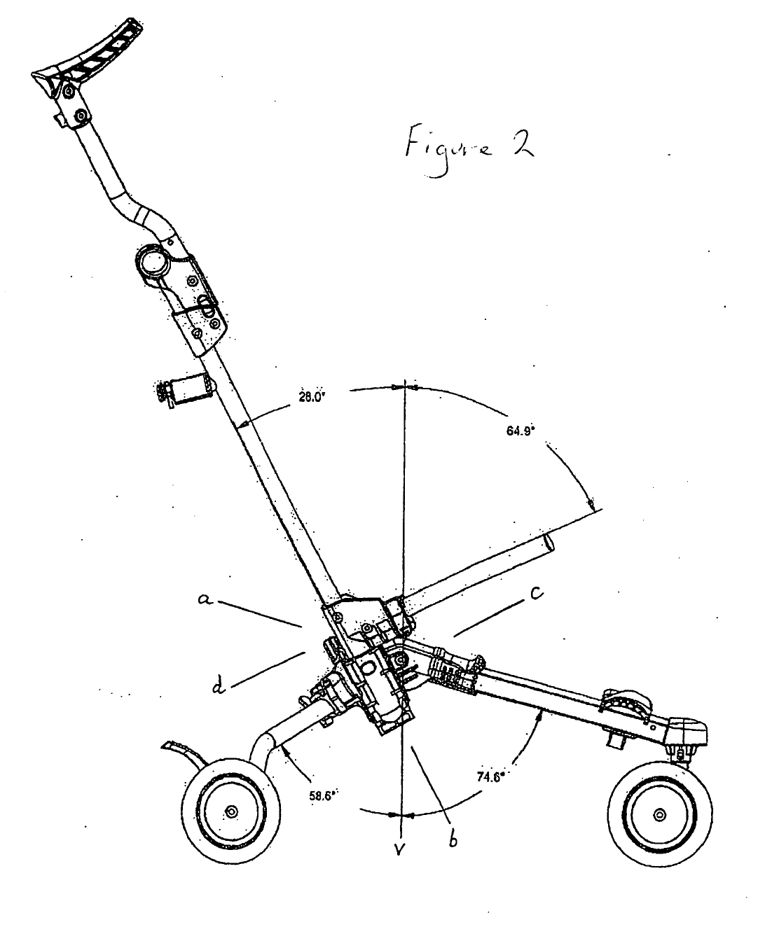

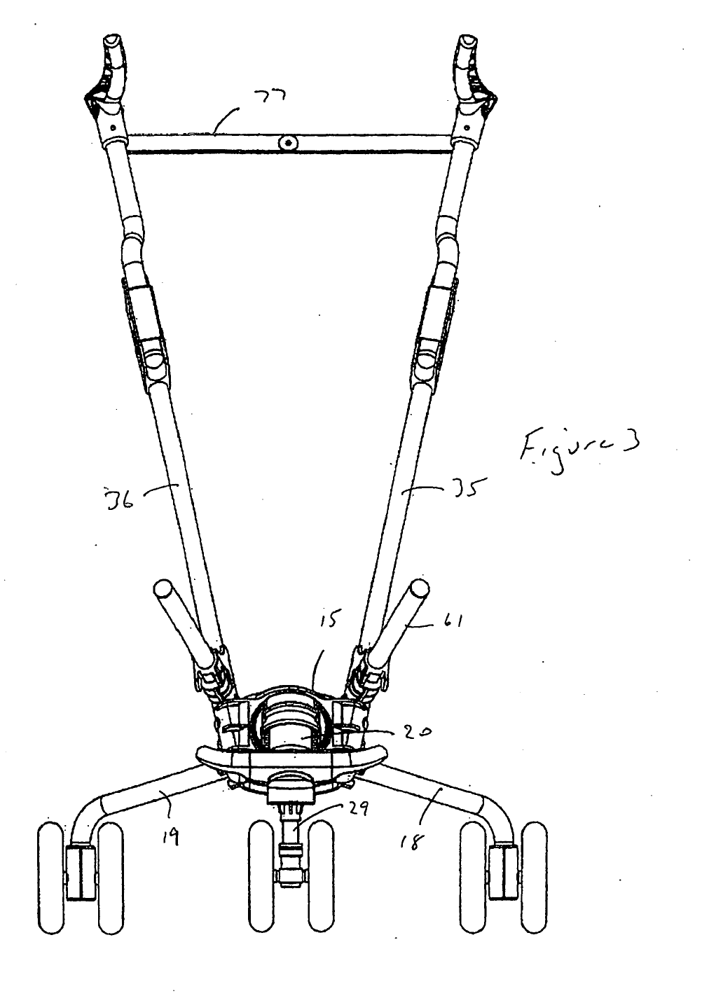

It can be seen particularly in FIG. 2 that the connection of the mounting body 15 on the support legs 18, 19 and 20 results in a reclining angle of the mounting body and the co-linear upwardly extending arms 35,36 relative to the ground engaging wheels 21 when on a flat horizontal surface.

The upright extending arms 35, 36 comprise lower arm 35a, 36a connected to and extending from the mounting body 15 and joined by respective elbow joints 38 to upper arms 35b, 36b and topped respectively by handles 39. The elbow joints 38 and shape of the upper arms 35b, 36b allow the upright arms to extend substantially in the plane formed by the reclining angle of the mounting body 15.

A support frame 45 in the form of a seat is mounted on the upright arms 35, 36 for supporting a child or other load. This is provided by support posts 61, 62 mounted hingedly on the front of the arms 35, 36. The load can rest against flexible material or other rigid material extending between the posts 61, 62 and flexible material or other rigid material extending between the lower arms 35a, 36a. However a fixed structure such as a car baby capsule or a golf club bag can fit directly onto the framework formed by the support posts and arms and even the support legs.

Looking at the operation of the rotation means in detail with reference to FIGS. 7.1, 7.2, 7.3 and 7.4 there is shown a collapsing mechanism having the features of the mounting body 15 having a central cavity 42 in which the rotating disc 41 is mounted with front and rear legs 18, 19 and 20 attached to front surfaces of the disc 41. Within the rotating discs are linear channels 81 extending on opposite sides of the centre of the disc 41 and within which are springs 82 pushing plungers 81 along the linear channels in an outwardly direction. The plungers 82 thereby extend beyond the circular cavity into adjacent collinear channels 84 extending to the inner V-shaped cavity of the side sheaths in which the upright arms are pivotally mounted. Spacer balls 85 fit partially in the adjacent collinear channels 84 and engage the plungers 82 on one side and the upright arms 35, 36 on the other side above the pivot connection. By this engagement, bending of the cross brace 77 and pivotal convergence of the upright arms 35, 36 will push the spacer balls 85 against the plunger such that at the innermost position of the upright arms 35, 36 within the V-shaped cavities of the side sheaths 45, 46 the plungers are just within the circular cavity 42 holding the rotating disc and therefore allow rotation thereof.

To prevent accidental rotation of the rotating disc 41, a twist lock 75 is mounted on the top surface of the mounting body 15 between the upright arms 35, 36 which has a first length with abutment ends 76 where the first length is sufficient to have the abutment ends 76 engage the upright arms 35, 36 in a maximum converging position defined by the limitations of movement within the V-shaped cavity of the side sheaths 45, 46. By the twist lock having a smaller length and being able to rotate and thereby disengage the upright arms, the arms are able to pivotally converge and act in opposition to the spring loaded plungers 82 and thereby allow rotation of the rotating disc 42 and attached front and rear support legs. Therefore it can be seen that the stroller or push chair 11 includes a plurality of elongated linear support legs 18, 19, 20 with each connected to and extending from the mounting body 15. The legs are arranged having one front support leg 18 extending from a front portion of the mounting body 15 and two support legs 19, 20 extending from a rear portion of the mounting body 15. The stroller or push chair 11 further includes two linear arms 35 36 with handles at an upper end and connected in pivotal arrangement within the cavity of the mounting block 15.

Each of these features is capable of movement. The front support leg 20 is able to pivotally move from an outwardly splayed position to a position substantially adjacent the plane of the mounting body and upright arms. The limiting shoulder piece prevents movement in one direction but allows movement in the other direction. If the plane of the mounting body 15 and upright arms 35, 36 is identified as b-b and is at a reclining angle b° to the vertical then the angle of the front support leg along a-a is at an angle a to the plane b-b and can pivotally move to coextend substantially parallel to the plane b-b. The front support leg is also able to rotate 180 with the rotating disc 41 of the mounting body 15. In this way the ground engaging wheel can extend from a lower side of the mounting body to be on an upper side of the mounting body 15.

The rear support legs 18, 19 are also able to pivotally move from an outwardly splayed position to a position substantially adjacent the plane of the mounting body and upright arms and rotate 180° with the rotating disc 41 of the mounting body 15. That is they can move from a line c-c at an angle c° to the plane b-b and can pivotally move to coextend substantially parallel to the plane b-b.

The support posts 61, 62 extending from the lower arms 35a, 36a are able to pivot back to be adjacent and coextensive with the lower arms 35a, 36a. They extend along plane d-d which is substantially at right angles to the plane b-b and can pivotally move to coextend substantially parallel to the plane b-b.

The upright arms 35, 36 extend upwardly from the mounting block 15 in the plane of b-b. However the V shape cavity of the outer side sheaths allow movement of the upper arms 35, 36 from outwardly converging along line e-e as shown in FIG. 1 with a cross brace at the top end near the handles maintaining that spacing. However with bending of the cross brace at the predefined central hinge the upright arms 35, 36 can move towards each other at the top end to be substantially parallel. Also the upper arms 35b, 36b are able to pivot at the elbow joints 38 to be adjacent and coextensive with the lower arms 35a, 36a in the plane b-b. The upper arms 35b, 36b can pivotally rotate at the elbow joints 38 180° to coextend with the lower arms 35a, 36a substantially in or parallel to the plane b-b.

The internal side walls of the cavity of the mounting block 15 provide a maximum lateral divergence of the upright arms 35, 36 when in use in a supporting arrangement. The pivotal connection allows the upright arms 35, 36 to converge to substantially coextend for a smaller volume transportable position. In use the upright arms 35, 36 allow for maneuverability of the stroller or push chair 11.

In use the stroller or push chair 11 is changeable from a first supporting position in which the support legs 18, 19, 20 extend in a first direction and allow loads to be supported on the collapsible supporting structure to a second transportable position in which the support legs extend in a second direction substantially coextensive with the upright arms 35, 36 and allow ready transportability. The mechanism for such operation is detailed herein.

Each of the support legs 18, 19, 20 are connected to the one mounting body 15 by connection means having rotation means and pivoting means such that the support legs can extend from the mounting body in a first splayed arrangement which forms the supporting position of a load to a second arrangement in which the support legs are pivoted inwards to substantially extend alongside the mounting body and rotated such that the support legs extend substantially alongside the upright arms.

The rotation means allows the support legs 18, 19, 20 to move from the first supporting position to the second transportable position by being rotated. The amount of rotation is up to 180° such that the first supporting position is opposite the second transportable position. This allows for substantial co-extension of the support legs 18, 19, 20 and the upright arms 35, 36 which substantially decrease the volume of space used by the stroller or push chair 11 in the collapsed transportable position relative to the useable supporting position.

The pivoting means of the connection means allows for pivotal movement of the attached support legs 18, 19, 20 from a supporting position at an angle to the mounting body to a collapsible position adjacent the mounting body.

One form of the systematic steps for conversion from the first supporting position allowing loads to be supported on the collapsible supporting structure to a second transportable position is by:

i. Rotate the support posts 61 around pivotal connection to the lower arms 35a, 36a so as to be coextensive with the lower arms;

ii. Rotate the twist lock 75 on the top of the mounting body 15 between the upright arms 35, 36 to allow them to pivot inwards;

iii. Bend the cross brace 77 between the upright arms 35, 36 and converge them towards each other to a substantially parallel relationship which allows rotation of the rotating disc 41 by opposing operation of the lock by the spring loaded plungers 82 back within the circular cavity 42 in which the rotating disc 41 is mounted;

iv. Simultaneously rotate the front and rear support legs 18, 19 and 20 by rotation of the rotating disc 41 of the mounting body such that the wheels are no longer ground engaging and are now splayed upwards relative to the usual in use position;

v. Release the locking mechanism of the front post by sliding the circumferential cover 54 along the front leg 20 away from the pivot guard 51 to allow pivotal rotation of the front support post from an outwardly splayed angle a from the upright arms 35, 36 to be parallel and coextensive with the lower arms;

vi. Pivotally rotate the rear support posts from an outwardly splayed angle a from the upright arms 35, 36 by converging them to be parallel and coextensive with the lower arms; and

vii. Pivotally rotate the upper arms 35b, 36b around the elbow 38 to be parallel and coextensive with the lower arms 35a, 35b. Clearly some of these steps can be undertaken in different orders.

The supporting frame 45 of the stroller or push chair 11 is a seating system which can be modified from a voluminous supporting structure to a minimized volume transportable structure. The supporting frame is mounted on the upright arms 35, 36 of the stroller or push chair 11.

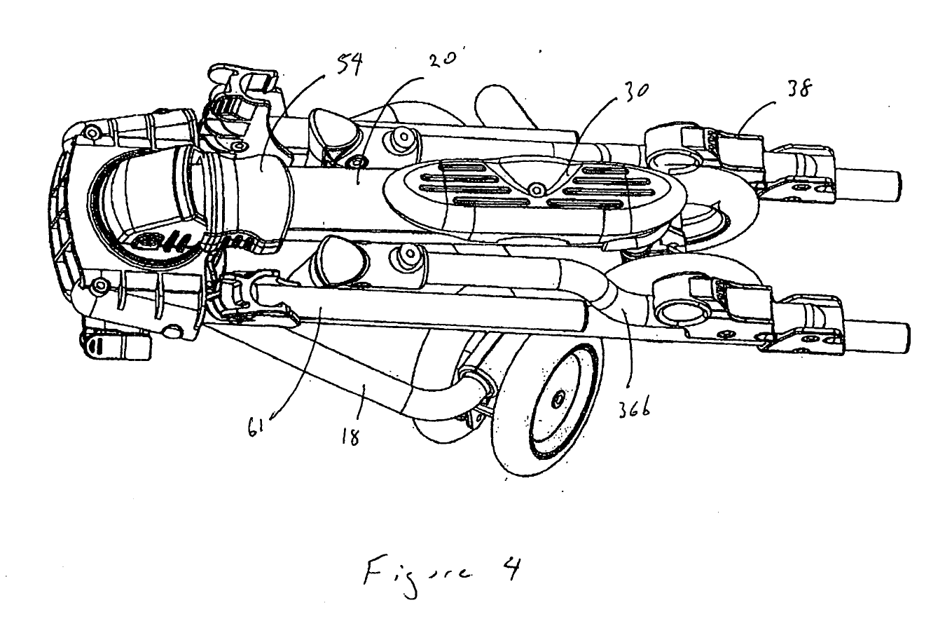

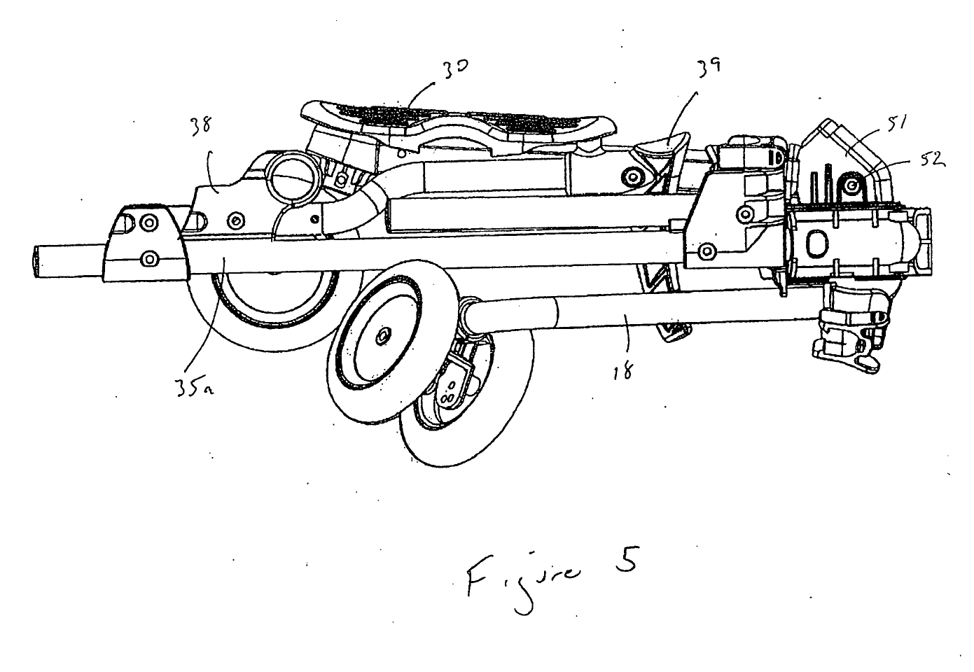

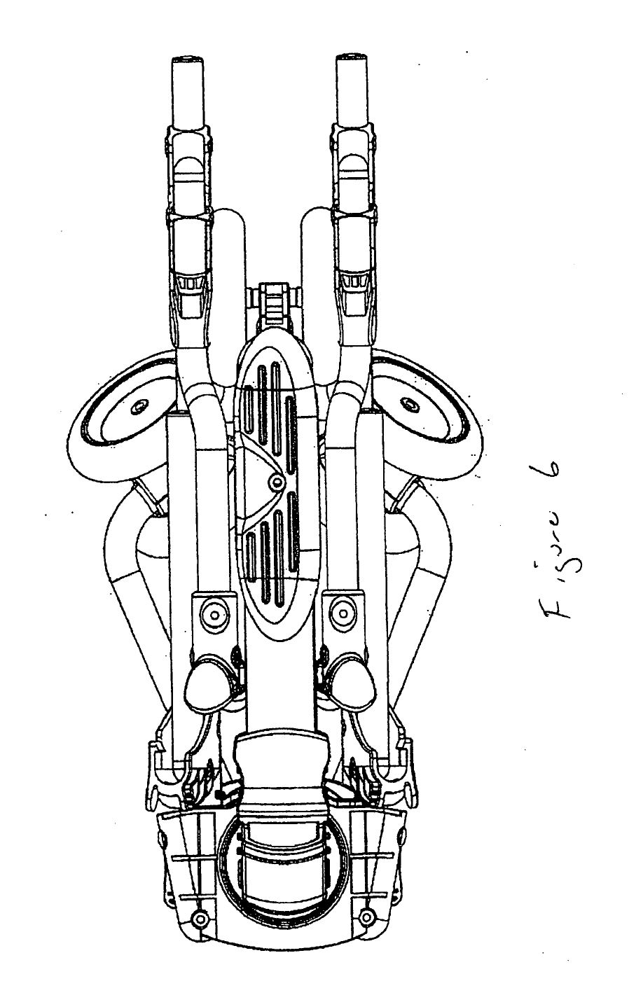

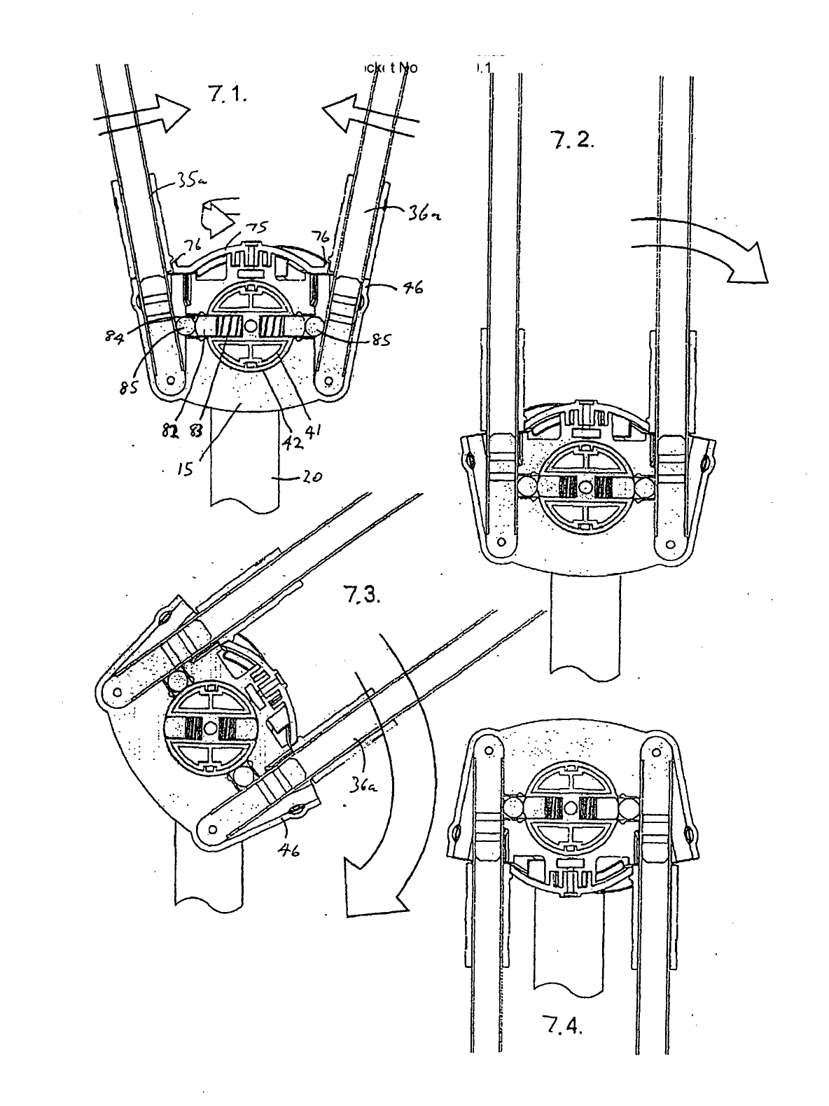

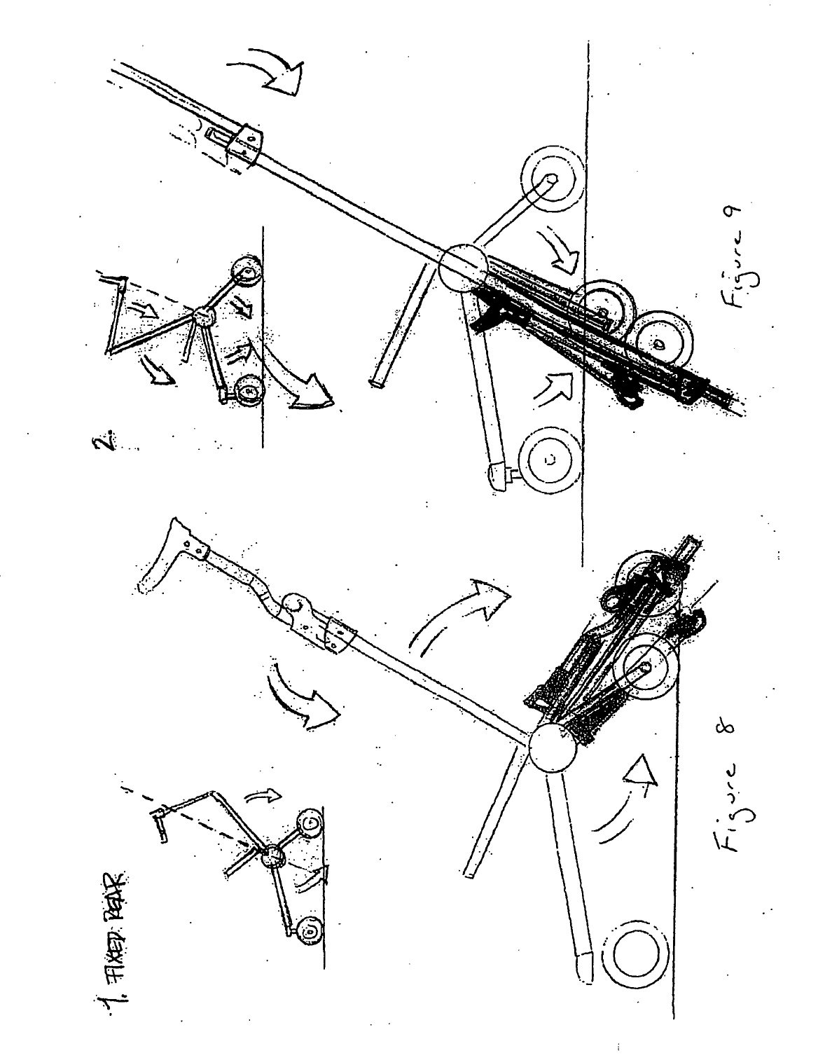

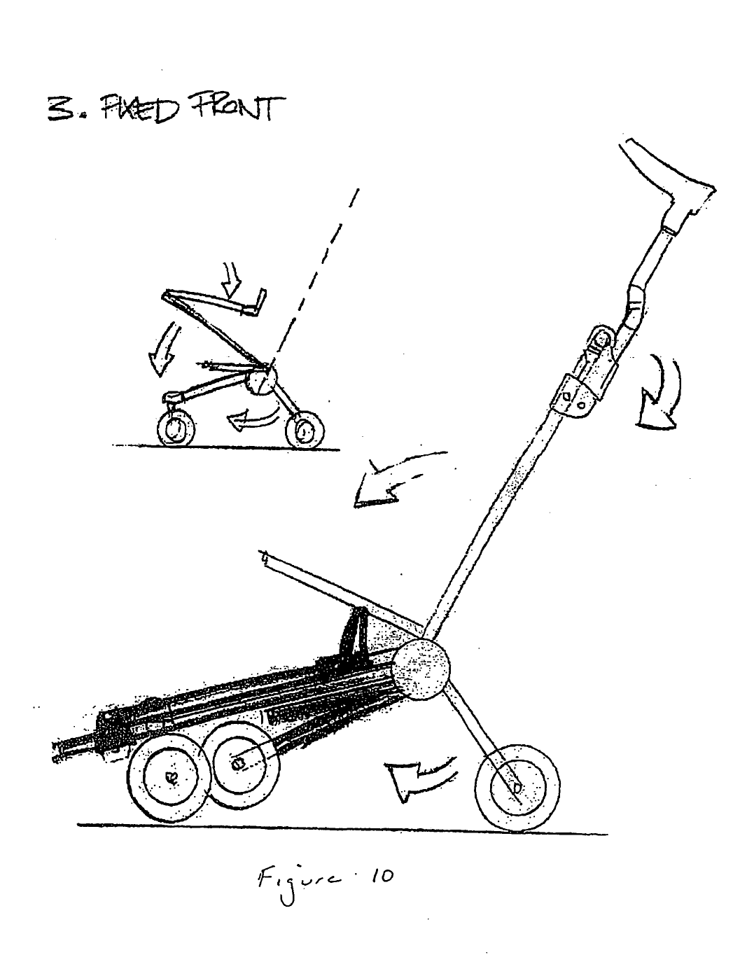

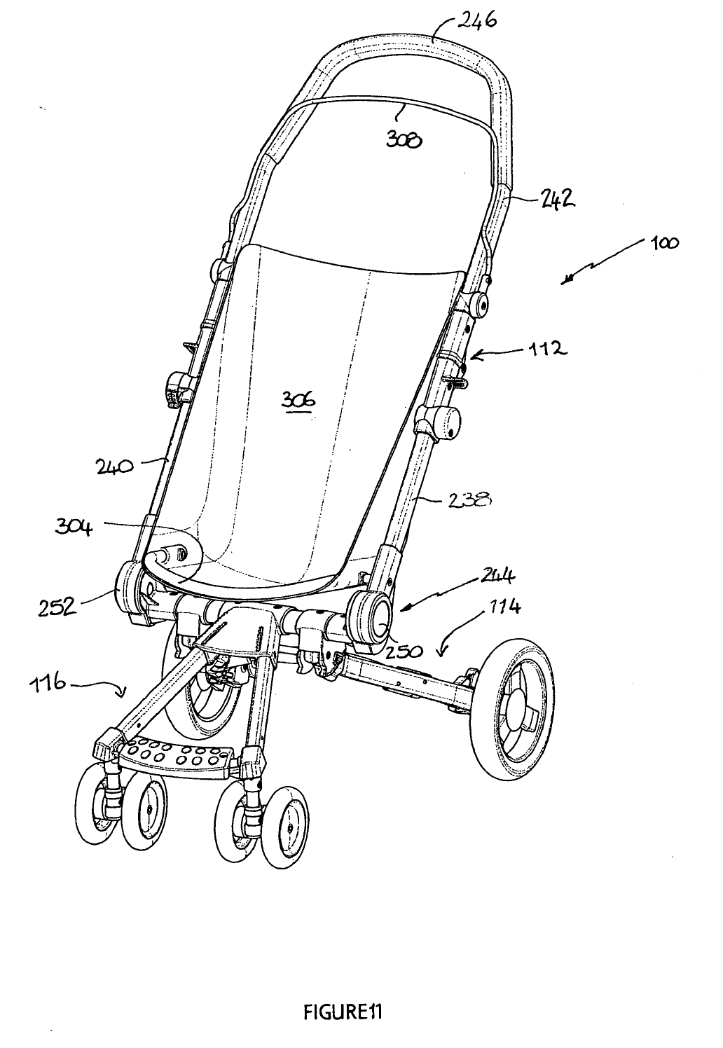

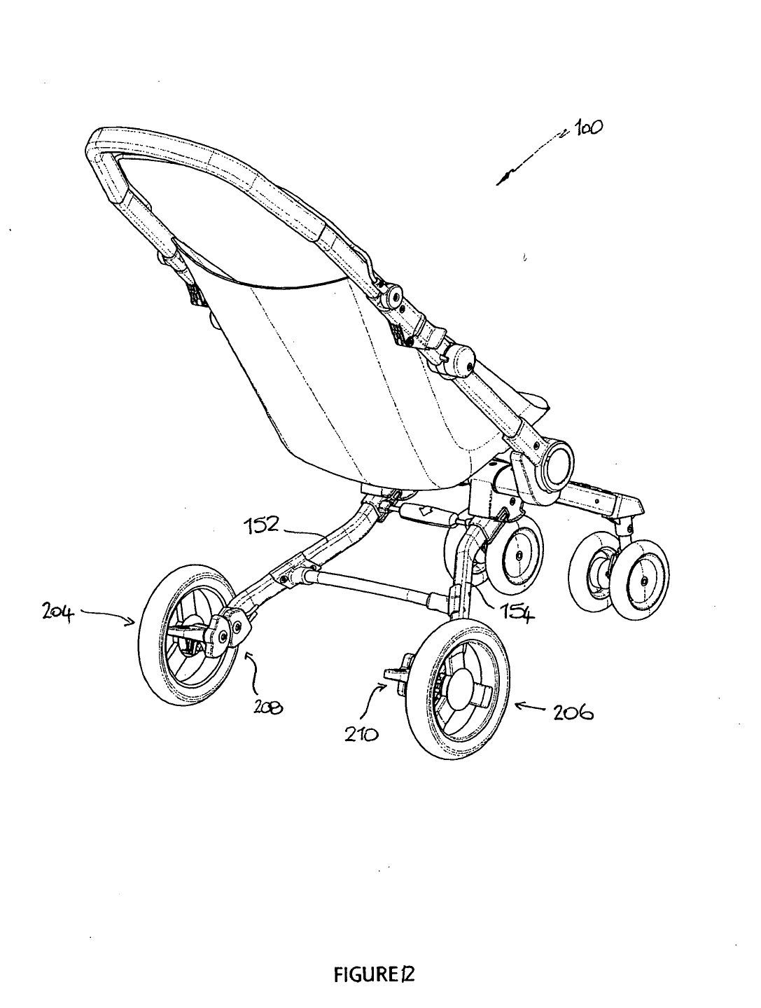

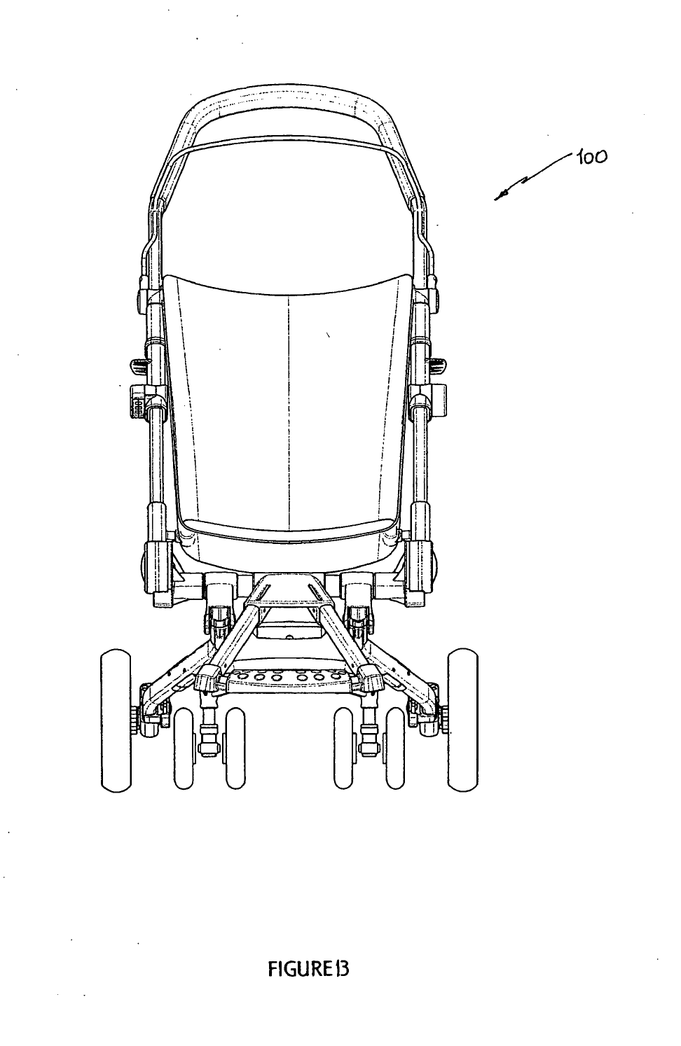

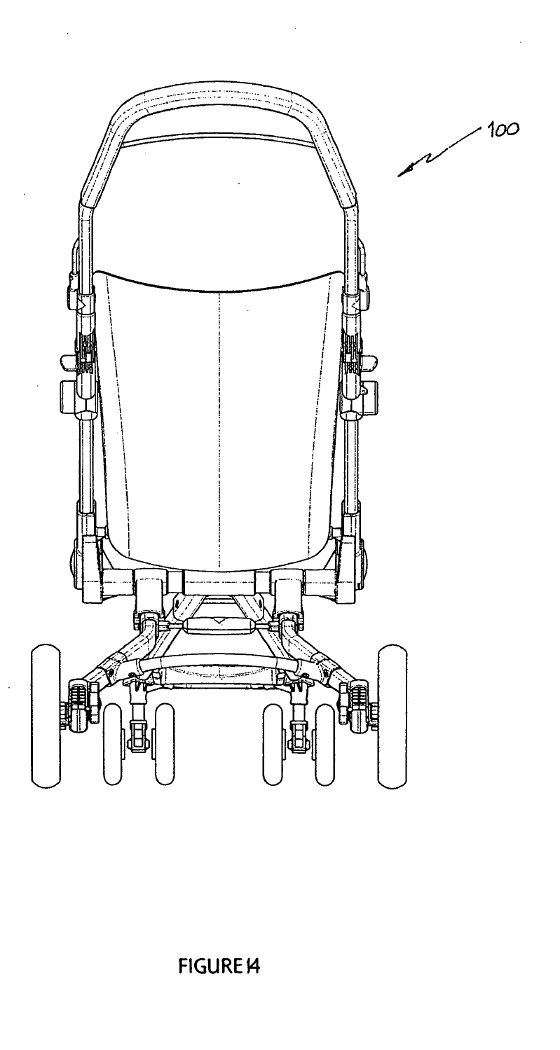

As shown in FIGS. 4 to 6 the collapsible supporting structure is shown in a collapsed transportable position.

Referring to FIGS. 8, 9 and 10 there are shown various forms of mounting of the front and rear legs and upright arms from a central mounting body in such a manner the legs and arms can be moved to a substantially coextensive position to minimize carrying volume. This can be by rotation of all of the front and rear legs and upright arms in a single plane such that they are coextensive. The selection of which part remains in fixed position and which other parts need to be rotated to be alongside and substantially co-extensive provide the various forms of these embodiments.

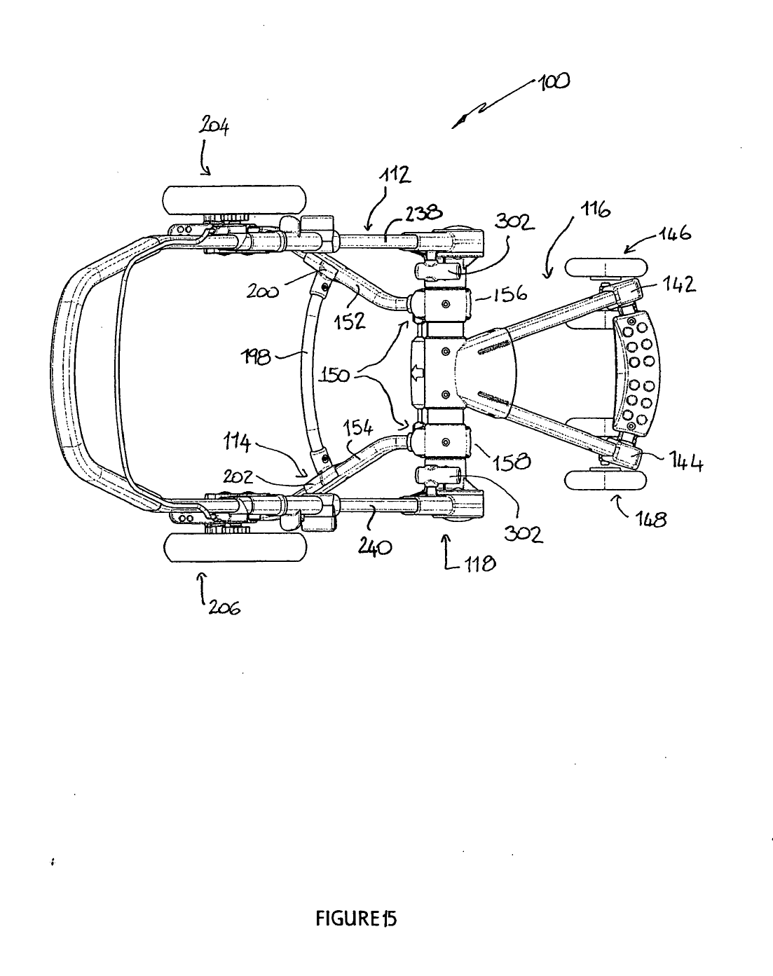

Referring now to FIGS. 11 to 15, there is shown a collapsible supporting structure 100 in the form of a stroller. The collapsible supporting structure 100 includes a support frame 112 for supporting a load, a first leg support assembly 114 and a second leg support assembly 116. In this example, the first support leg assembly 114 is adapted to project rearwardly from the stroller, whilst the second support leg assembly 1 16 is adapted to project forwardly from the stroller. The support frame is in the form of two upwardly extending arms joined at their upper end.

Second Support Leg Assembly

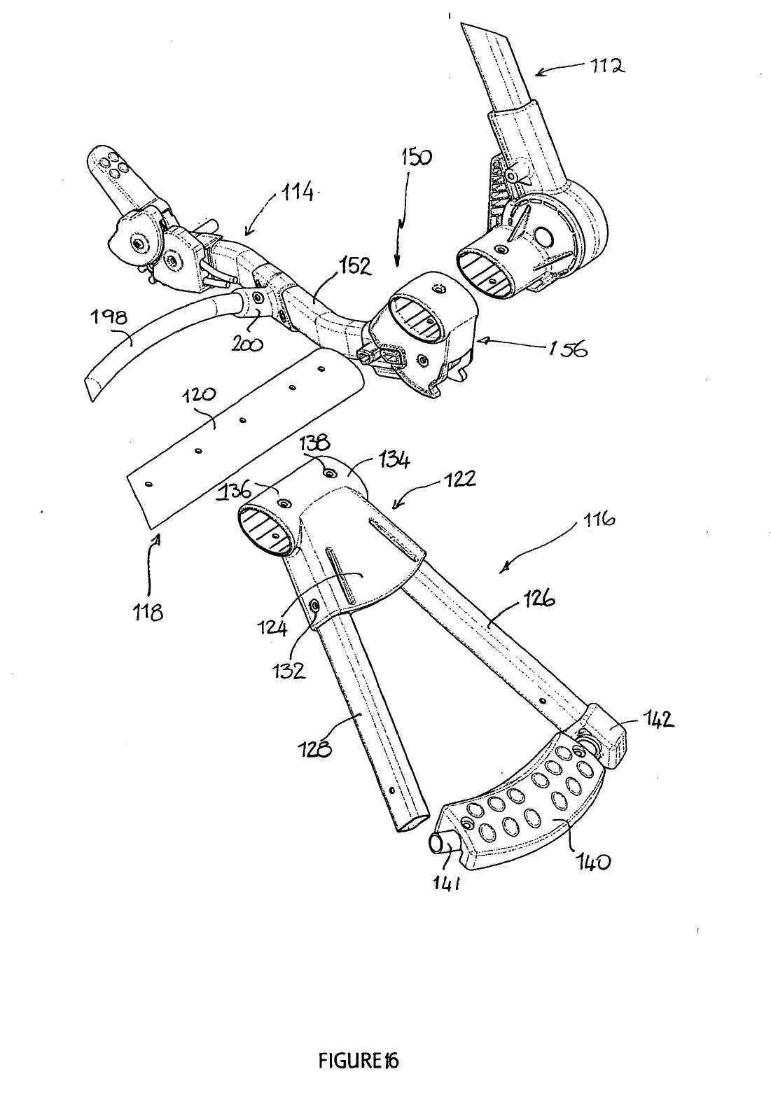

As shown in FIGS. 15 and 16, the collapsible supporting structure further includes a mounting body 118 to which the first support leg assembly 114, second support leg assembly 116 and support frame 112 are connected. The mounting body 118 acts as a central hub to which each of these three principle elements of the collapsible supporting structure are connected. As can be best seen in FIG. 16, the mounting body in this example includes a mounting bar 120 extending laterally across the width of the stroller. (FIG. 16 is only a partial view and thus only the right hand side of the mounting bar 120 can be seen. The left hand side is a mirror image.) In other embodiments however, the mounting body need not be of a bar or other elongate member but may be of any convenient form suitable for filling the functionality described herein.

The second leg assembly 116 is connected to the mounting bar 120 by a leg connection arrangement 122. The leg connection arrangement 122 includes a leg mounting block 124 adapted to receive leg members 126 and 128 of the second support leg assembly 116. The leg mounting block 124 secures and maintains the leg members 126 and 128 in a splayed or V-shaped configuration so that the separation between the leg members 126 and 128 is greater at the distal ends of the leg members 126 and 128 than at the proximate ends. Each of the leg members 126 and 128 are maintained in position by screws or other fixation devices passing through corresponding apertures in the leg receiving portion 130 and the leg members 126 and 128 (one such aperture is referenced 132 in FIG. 16).

The leg mounting block 124 further includes a sleeve 134 adapted to be placed around the mounting bar 120 and centrally positioned thereon by means of fastening members and corresponding apertures formed in the sleeve 134 and mounting bar 120. Two such apertures are referenced 136 and 138 in FIG. 16.

The support leg assembly 116 further includes a footrest 140 secured between distal ends of the leg members 126 and 128 by means of footrest mounting brackets 142 and 144. The footrest 140 is secured to a footrest strut 141 extending between, and secured at each end to the footrest mounting brackets 142 and 144. As shown in FIG. 15, the footrest mounting brackets 142 and 144 are further adapted to receive and have connected thereto wheel assemblies 146 and 148. In this example, the wheel assemblies are of the dual wheel type, however in other embodiments different wheel assemblies may be used.

First Support Leg Assembly

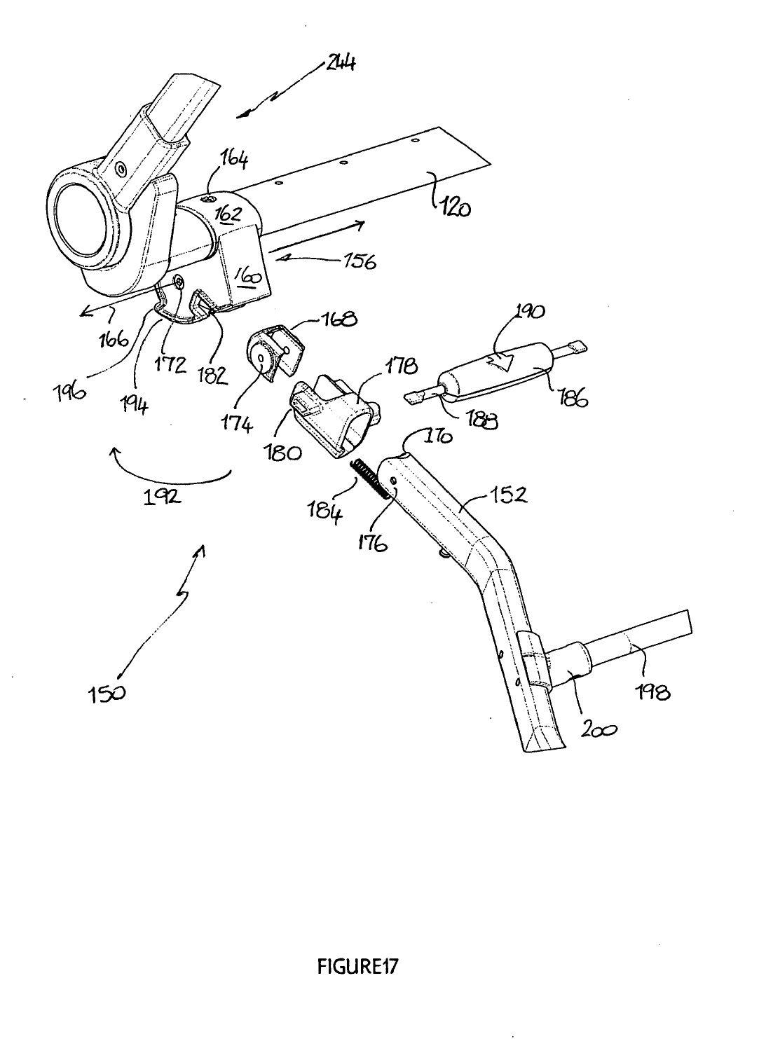

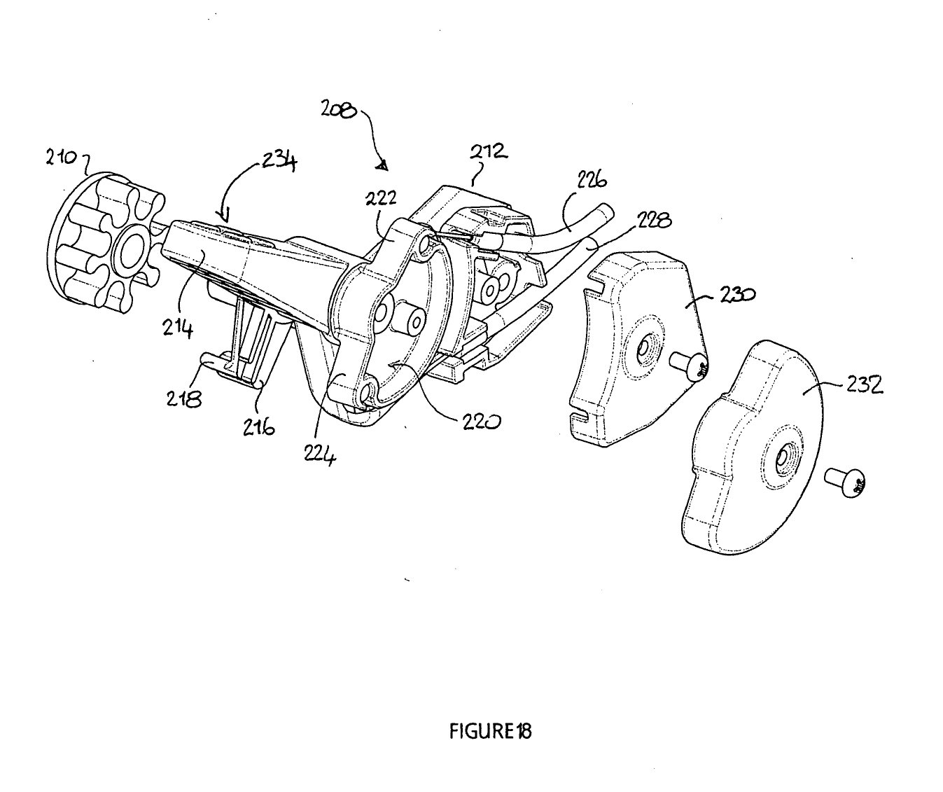

As shown in FIGS. 15 to 17, the support leg assembly 114 is connected to the mounting bar 120 by a leg connection arrangement 150. The support leg assembly 114 includes two rearwardly projecting leg members 152 and 154. The leg connection arrangement 150 includes separate leg mounting blocks 156 and 158 respectively adapted to interconnect the leg members 152 and 154 to the mounting bar 120. The leg mounting blocks 156 and 158 are positioned on the mounting bar 120 to either side of the centrally positioned leg mounting block 124. As can be best seen in FIG. 17, the leg mounting lock 156 includes a leg receiving portion 160 for receiving and securing the leg member 152 to the leg mounting block 156, and an integrally formed sleeve 162 for securing around the mounting bar 120 by screws or other fixation devices and corresponding apertures such as that referenced 164.

The leg connection arrangement 150 is further adapted to enable pivotal movement of the leg support assembly 114 between a first leg supporting position in which the support leg assembly 114 extends in a first direction to support a load borne by the collapsible supporting structure 100 (as shown in FIGS. 11 to 15) and a collapsed position in which the support leg assembly extends in a second direction to allow for ready transportability of the collapsible supporting structure (as will be discussed in relation subsequent figures). This pivotal movement is facilitated, in the case of the leg member 152 and leg mounting block 156 by the pivotal connection of the leg member 152 about a pivotal axis 166 extending in the same direction and parallel to the longitudinal axis of the mounting bar 120. Pivotal movement of the leg member 152 about the axis 166 is facilitated by means of aligned apertures in the proximate end of the leg member 152 and in the leg receiving portion 160. In this example, a leg termination piece 168 is positioned over the proximate end 170 of the leg member 152 and apertures 172, 174 and 176 respectively in the leg receiving portion 160, leg termination member 68 and proximate end 170 of the leg member 152 are aligned to receive a pin or other interconnecting member. It will be understood that the functioning of the corresponding leg mounting block 158 is identical to that just described.

When placed in an operative load bearing configuration, as illustrated in FIGS. 11 to 15, the support leg assembly 114 is releasably locked in a rearwardly extending direction. As can be seen from FIG. 17, this is achieved by locked members positioned around proximate ends of the leg members 152 and 154 and corresponding recesses formed in the leg mounting blocks 156 and 158. In the case of leg member 152, and leg mounting block 156, a locking member 178 is adapted to be positioned around the proximate end 170 of the leg member 152 and the leg termination member 168. The locking member 178 includes a lateral projection 180 adapted for slidable engagement in corresponding recess 182 formed in the leg receiving portion 160 of the leg mounting block 156. The recess 182 acts as a stop member to prevent pivoting movement of the support leg assembly 114 about the pivot axis 166 when the lateral projection 180 is engaged in the recess 182. A spring 184 or other biasing member is used to ensure that the locking member 178 is biased towards the leg receiving portion 160 so that the lateral projecting member 180 is biased to engage in the recess 182 and accordingly lock the support leg assembly 114 in the rearwardly projecting orientation shown in FIGS. 11 to 15.

When it is desired to place the collapsible supporting structure in a collapsed configuration for ready transportability, the support leg assembly 114 is released from the rearwardly projecting configuration shown in FIGS. 11 to 15, and pivoted about the pivot axis 166 towards a forwardly projecting position. To facilitate the release of the lateral projection 180 of the locking member 178 from the corresponding recess 182 in the leg receiving portion 160, a lock release handle 186 and corresponding lock release bar 188, around which the handle 186 is positioned, is provided. The lock release bar 188 extends between and is secured to the locking members 178. Pulling the lock release handle 186 towards the distal end of the leg members 152 and 154 in the direction indicated by the arrow 190 in FIG. 17 overcomes the biasing of the locking members 178 and causes the lateral projections 180 on the locking members to be slidably disengaged from the corresponding recesses 182 in the leg receiving portions 160. The support leg assembly 114 is then able to be rotatably displaced about the pivot axis 166 in the direction of the arrow 192 towards the support leg assembly 116. During this rotational displacement the lateral projection 180 of the locking member 178 slides over a caming surface 194 in the leg mounting block 158 towards a shoulder 196, after which, the lateral projection 180 engages behind the shoulder 196 so as to releasably lock the support leg assembly 114 in a forward projecting orientation. Alternatively, the shoulder 196 may not be provided and the leg assembly may be unlocked in the collapsed configuration.

As shown in FIG. 15, the support leg assembly further includes a strut 198 extending between the leg members 152 and 154. The strut 198 is secured to the leg members 152 and 154 by strut connection pieces 200 and 202. Wheel assemblies 204 and 206 are respectively fitted to the distal ends of leg members 152 and 154 of the support leg assembly 114.

Brake Assemblies

As best shown in FIGS. 12 and 18, each of the wheel assemblies 204 and 206 include a single wheel only. Each wheel is connected to the distal ends of leg members 152 and 154 by means of linked brake assemblies 208 and 210. As seen in FIG. 18, the brake assembly 208 includes a rear brake cog 210 mounted about an axle of the wheel forming part of the wheel assembly 204. A brake mounting bracket 212 is secured to the distal end of the leg member 152, and supports a pivotally mounted brake lever 214. The brake lever 214 includes a laterally projecting arm 216 having a cog engagement member 218 extending from one end. The brake lever 214 is pivotally mounted to the brake bracket 212 by a cable operating bracket 220 including laterally projecting wings 222 and 224. A first brake cable 226 is secured to the wing 222, whilst a second brake cable 228 is secured to the wing 224. The cable operating bracket 220 and the ends of the brake cables 226 and 228 connected thereto are covered by brake housings 230 and 232. When rotation of the wheel forming part of the wheel assembly 204 is to be prevented, the brake lever 214 is depressed in the direction of arrow 234 to cause engagement of the member 218 between the teeth of the cog 210 thus preventing rotation of the wheel. The brake cables 226 and 228 may be connected to an identical brake assembly forming part of the wheel assembly 206. However in a preferred embodiment the upper brake cable 226 and lower brake cable 228 are respectively connected to the lower brake cable and the upper brake cable of the other brake assembly. Accordingly, depression of the brake lever 214 causes rotation of the brake cable connection 220 about a pivot point 236 to thereby increase tension on the brake cable 226 and decrease tension on the brake cable 228 to cause a corresponding depression of the brake leaver in the brake assembly associated with the wheel assembly 206. In this way, the two brake assemblies are linked so as to prevent or allow rotation of the wheels forming part of the wheel assemblies 204 and 206 simultaneously.

Support Frame

As shown in FIG. 11, the support frame 112 includes, in this example, lower frame members 238 and 240 and a curved upper frame member 242. An upper end of the lower frame member 240 is pivotally connected to one end of the upper frame member 242, and an upper end of the lower frame member 238 is pivotally connected to the other end of the upper frame member 242. The lower ends of the lower frame members 238 and 240 are connected to the mounting bar 120 by means of a frame connection arrangement 244. The upper frame member is provided with a plastic moulded cover 246 to enable the user to comfortably grip the top of the upper frame member 242 at locations that are convenient for a user. The frame connection arrangement 244 includes frame mounting blocks 250 and 252 respectively connecting ends of the lower frame members 238 and 240 to the mounting bar 120. It will be appreciated from FIG. 11 that the lower frame member 138 and a straight connected portion of the upper frame member 242 define an arm. Likewise another arm is defined by the lower frame member 140 and the corresponding straight portion of the upper frame member 242. Both arms extend upwardly from the mounting body.

Support Frame Mounting

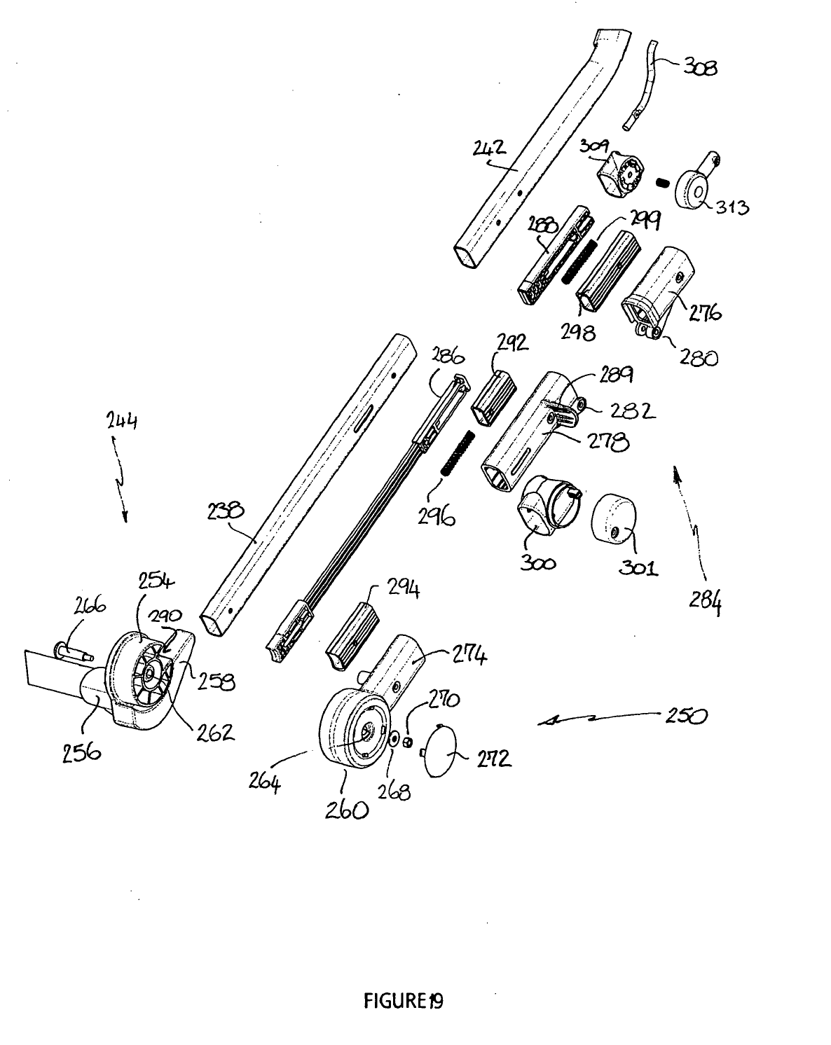

As shown in FIG. 19, the frame mounting block 250 includes a first disc member 254 and integrally formed sleeve 256 for mounting about one end of the mounting bar 120. A stop member 258 is further integrally formed with the disc member 254 in order to prevent rotation of the support frame beyond the reclined position shown in FIGS. 11 to 15 when the stroller is placed in a load bearing configuration. A disc cover member 260 engages around the disc member 254 and is secured thereto by means of apertures 262 and 264 passing centrally through both the disc member 254 and disc cover 260 and by bolt 266 washer 268 and nut 270, or other securing means. An end plate 272 is provided to hide the means of securing the disc member 254 and disc cover 260 from view. A sleeve 274 is integrally formed with the disc cover 260 and is adapted to receive the lower end of the frame member 238.

Upper and lower frame release housings 276 and 278 are respectively fitted around adjacent ends of the frame members 238 and 242. The upper and lower frame release housings 276 and 278 are pivotally interconnected at pivot points 280 and 282 to allow for rotational movement of the upper frame member 242 towards the rear of the collapsible supporting structure 100 with respect to the lower frame members 238 and 240. Thus the arms of the support frame 112 are retractable in length. The frame members 238 to 242 are maintained in a configuration whereby all frame members form part of the same plane by means of a frame locking arrangement 284.

A handle trigger 300 is provided about the lower release housing 278. Operation of the handle trigger 300 (and of the corresponding handle trigger positioned around the lower frame member 240) enables the relative pivotal movement of the upper frame member 242 with respect to the lower frame members 238 and 240, as well as enabling the pivotal movement of the lower frame members 238 and 240 away from the stop member 258 towards the front of the collapsible supporting structure 100.

The handle trigger 300 is slidably mounted relative to the lower release housing 278. The handle trigger is connected to a push rod 286. A projection 289 defines a palm rest for the user to retract the handle trigger 300 upwardly. A cap 301 covers the outer side of the handle trigger 300.

When the handle trigger 300 is pulled towards the upper frame member 242, the push-rod 286 is caused to move in the same direction and act on a locking member 288. In so doing, the locking member 288 is moved clear from juncture of frame release housings 276 and 278 allowing that joint to pivot about the aligned pivot points 280 and 282.

This same movement of the upper end of the push-rod 286 towards the upper frame member 242 causes the lower end of the push-rod 286 to be moved out of engagement with a recess 290 in the disc member 254 to thereby allow pivotal movement of the lower frame members 238, 240 away from the stop members 258.

The upper and lower ends of the push-rod 286 are respectively housed in sleeves 292 and 294. The push-rod 286 is biased towards a position in which its lower end is engaged in the recess 290 by a spring 296 or like resilient members. Similarly, the locking member 288 is housed within a sleeve 298 and maintained in a position in which the locking member 288 covers the juncture of frame release housings 276 and 278 by a spring 299 or like resilient member.

As can be best seen in FIG. 15, a seat frame support member 302 may be connected to one or both of the lower frame members 238 and 240 to support a seat frame bar or like member 304 (see FIG. 1). Material suitable for forming a seat 306 or other load bearing structure may be connected to the seat supporting bar 304. The seat 306 may additionally be affixed to one or more of the frame members 238 to 242, or other elements of the collapsible supporting structure as required.

A sun canopy support bar 308 may also be connected to one or more of the frame members 238 to 242 in order to enable the fitting of a sun canopy to the collapsible supporting structure 100 as shown in FIG. 19, the sun canopy bar 308 is pivotally mounted to the upper frame member 242. A sleeve 309 is mounted onto the upper frame member 242. The sleeve 309 presents an outer face 311 with a series of spaced detents. A dial member 313 cooperates with the detents to be located in a selected one of a two radial positions, i.e. either open or closed. The canopy bar 308 is received in a radial tube and thus may be positioned in a selected one of the two positions.

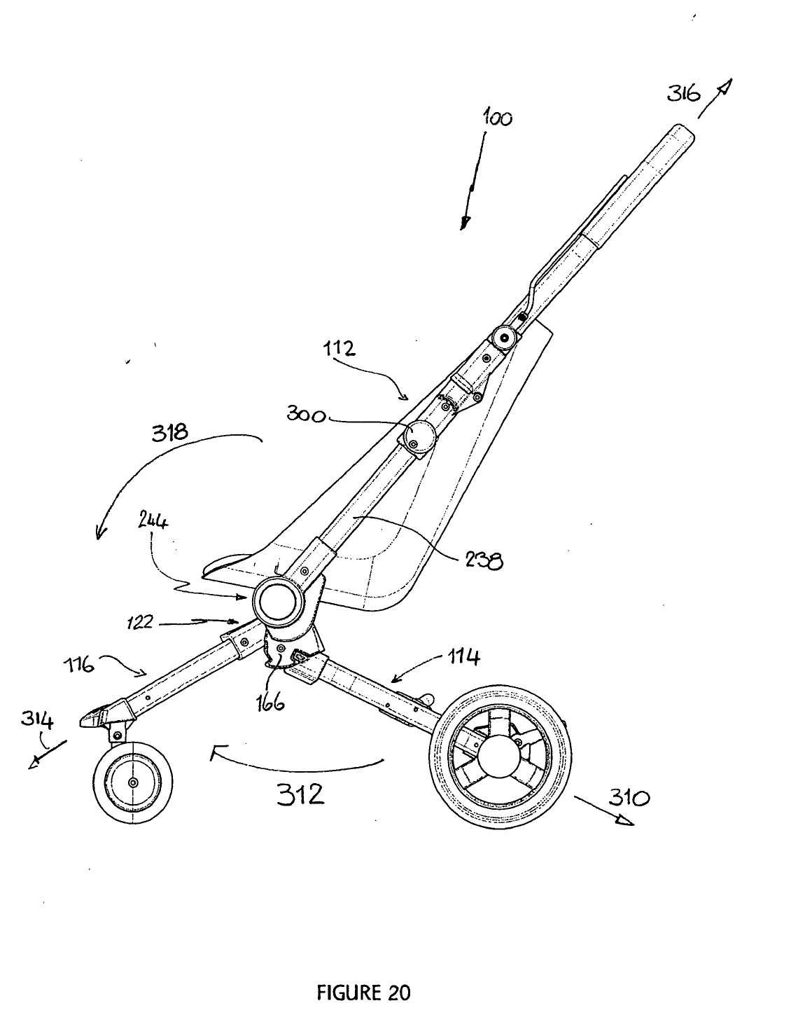

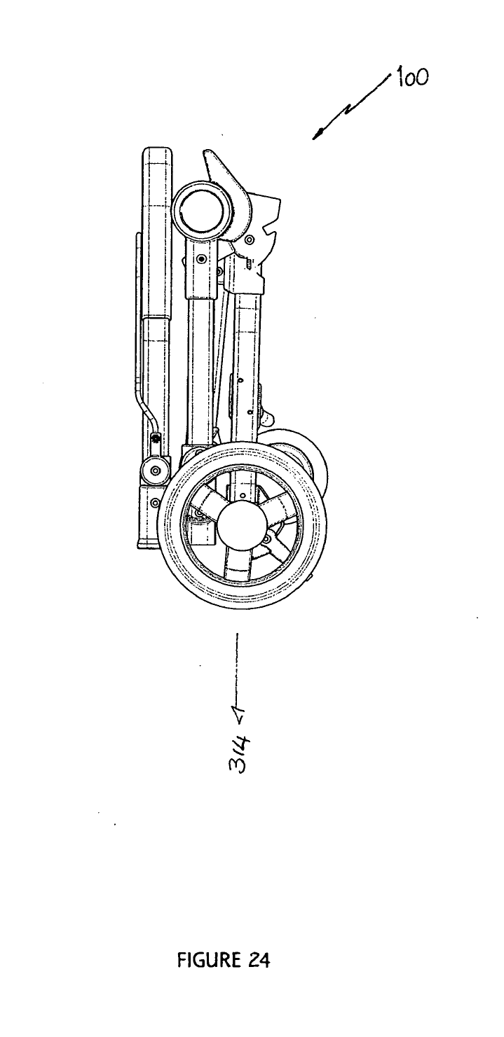

In the load bearing configuration shown in FIG. 20, the leg connection arrangement 150 supports a support leg assembly 114 in a leg supporting position in which the support leg assembly 114 extends in a first direction (namely the rearward direction indicated by the arrow 310) to support a load borne by the collapsible supporting structure. When the lock release handle 186 is pulled in the direction indicated by the arrow 190 (FIG. 17), and the lock members about the upper ends of the leg members 154 and 156 are disengaged from the grooves 182 formed in the leg mounting blocks 160, the support leg assembly 114 is pivoted about the pivot axis 166 in the rotational direction indicated by the arrow 312 (FIG. 20) to a leg collapsed position in which the support leg assembly 114 extends in a second direction (namely the forward direction indicated by the arrow 314 as shown in FIG. 24) to allow for ready transportability of the collapsible supporting structure. As can be seen from FIG. 20, the leg connection arrangement 122 maintains the support leg assembly 16 in a leg supporting position in which the support leg assembly 116 extends in that same forward direction. During pivoting, it will be appreciated that each point on the support leg assembly will move in an upright plane which extends in a front to rear direction.

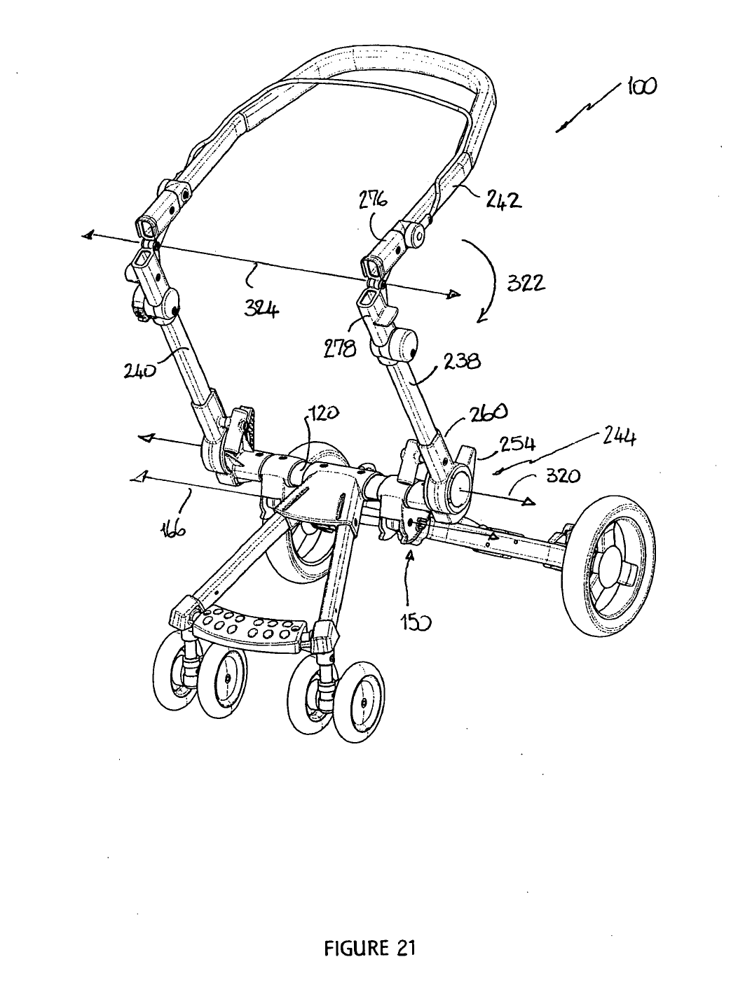

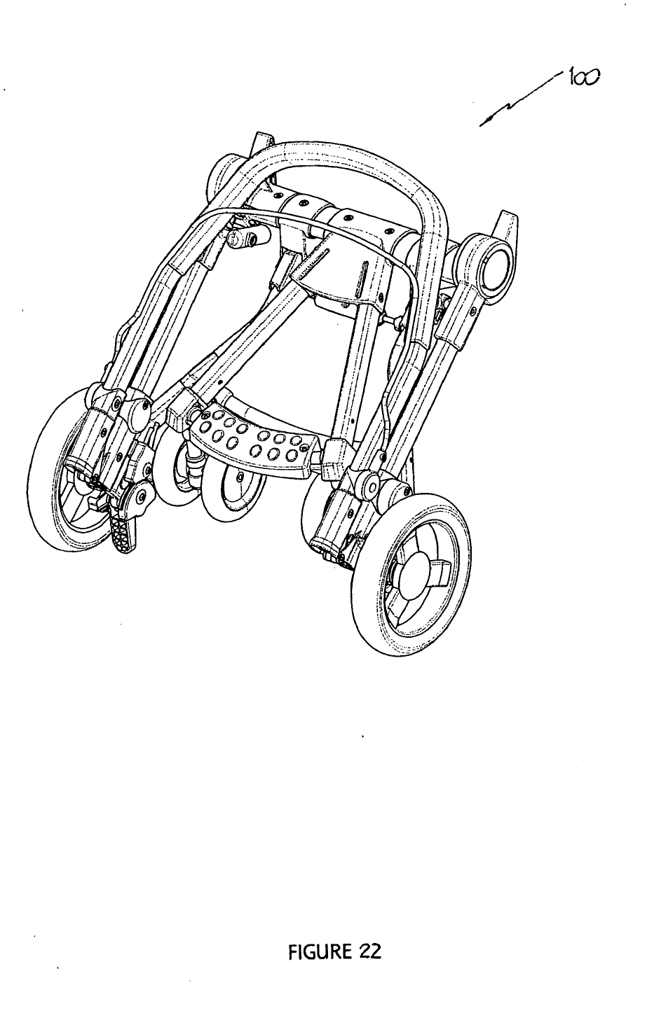

Similarly, the frame connection arrangement 244 supports the support frame 112 in a frame supporting position in which the support frame 112 extends in a first direction (the rearwardly inclined direction indicated by the arrow 316) to enable the load to be borne by the collapsible supporting structure but also enables pivotal movement of the support frame 112 between that position and a collapsed position in which the support frame 112 extends in the forward direction indicated by the arrow 314, namely the same direction in which the support leg assembly 116 extends and the same direction in which the support leg assembly 114 extends when the collapsible supporting structure is placed in a collapsed configuration. Accordingly, upon activation of the handle triggers 300, the lower frame members 238 and 240 are able to pivot towards the support leg assembly 116 in the rotation direction indicated by the arrow 318. The lower frame members 238 and 240 pivot about a rotational axis 320 (FIG. 21) defined by the centre points of the disc members 254 and disc covers 260. As the support frame 112 pivots about transverse axis 320, it will be appreciated that each point on the frame 112 moves through an upright plane which extends in the forward-rearwards direction.

As can be seen in FIG. 21, activation of the handle triggers 300 also enables pivotal separation of the upper frame member 242 from the lower frame members 138 and 240 so that the upper frame member 242 is pivoted in the rotational direction indicated by the arrow 322 towards the rear of the collapsible supporting structure. The relative pivotal movement between the lower frame members 238 and 240 and the upper frame member 242 occurs about a pivot axis 324 defined by the pivot points 280, 282 interconnecting the upper and lower frame release housings 276, 278 interconnecting the upper and lower frame members 238 to 242. Thus it will be understood that the arms forming part of the support frame 112 are both pivotable about the mounting body and foldable approximately midway along their length such that in the collapsed configuration, the resultant length of the arms is approximately the same as the length of the rear support leg assembly 114.

As can be seen from FIG. 21, the support leg assembly 114 is mounted to the leg connection arrangement 150 for rotation about a pivot axis 166 that is laterally offset from the longitudinal axis of the mounting bar 120. Similarly, the support frame 112 is mounted to the frame connection arrangement 244 for rotation about a pivot axis 320 that is also laterally offset from the longitudinal axis of the mounting bar 120. Advantageously, this enables the support leg assembly 114 and the support frame 112 to be pivoted to a position in which the support leg assembly 116, support leg assembly 114 and support frame 112 all extend in the same direction indicated by the arrow 314 in FIG. 24 but to remain in different planes and thereby facilitate the placement of the collapsible supporting structure in a compact form when in a collapsed configuration.

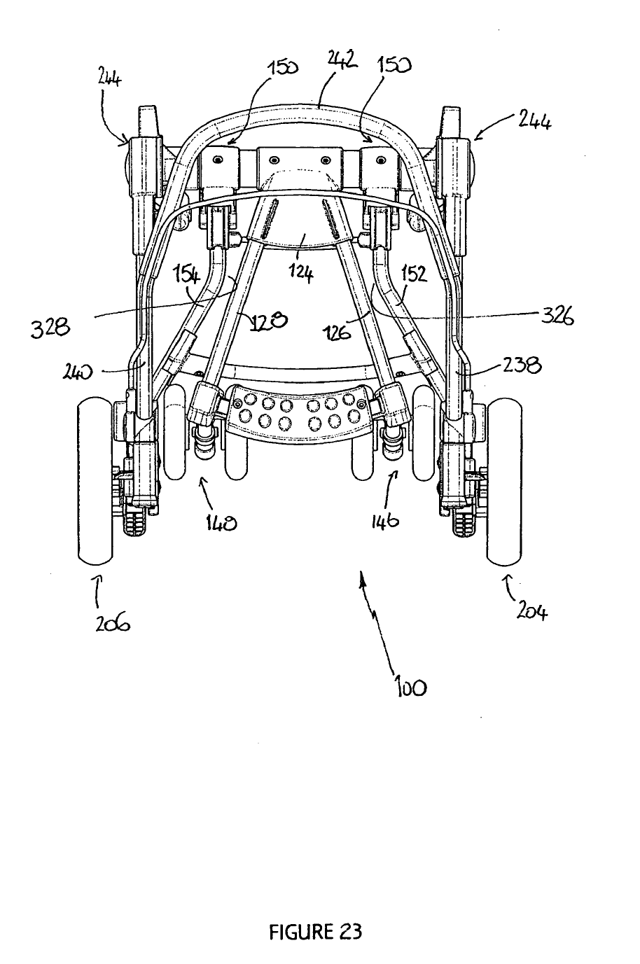

The leg connection arrangement 150 is adapted to support the support leg assembly 114 in the leg transportable position shown in FIGS. 23 and 24 so that the support leg assembly 114 is laterally offset from the support leg assembly 116. Similarly, the frame connection arrangement 244 is adapted to support the support frame 112 in a frame transportable position shown in FIGS. 23 and 24 so that the support frame 112 is also laterally offset from the support leg assembly 16. The leg members of the support leg assemblies 114 and 116 may be positioned or shaped so that, when the supporting structure 100 is placed in a collapsible configuration as shown in FIGS. 23 and 24, the leg members and/or wheels assemblies are interposed to avoid engagement with each other when the collapsible supporting structure 100 is placed in a collapsed configuration. The wheel assemblies 146 and 148 and leg members 126 and 128 are positioned and shaped so as to be interposed between the wheel assemblies 204 and 206 and the leg members 152 and 154. In this example, the leg members 126 and 128 are substantially straight and extend between the leg mounting block 124 and the wheel assemblies 146 and 148, whereas the leg members 152 and 154 are bent outwardly at elbows 326 and 328 so as to avoid contact with the leg members 126 and 128 and position the wheel assemblies 204 and 206 outwardly of the wheel assemblies 146 and 148.

Moreover, the frame members 238 to 242 of the support frame 112 are also positioned or shaped so that, when the supporting structure 10 is placed in a collapsible configuration, the frame members 238 to 242 are interposed with the leg members 126, 128, 152 and 154 and/or wheel assemblies 146, 148, 204 and 206 to thereby facilitate the adoption of a compact form when the collapsible supporting structure is placed in a collapsible configuration.

Finally, it is to be understood that various modifications and/or additions may be made to the collapsible supporting structure described above without departing from the spirit or ambit of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A collapsible supporting structure comprising:
a mounting body;
arms extending upwardly from the mounting body; and
front and rear wheeled support legs, wherein at least some of the front and rear legs and arms are pivotally mounted to the mounting body to enable pivoting about the mounting body such that each point on said some of the front and rear legs and arms moves in a fore-aft upright plane between an operative configuration and a collapsed configuration in which the front and rear legs and arms extend substantially coextensively,
wherein the arms have an extended configuration for use and a retracted configuration which results in a reduction of the overall length of the arms such that in the retracted configuration, the length of the arms approximates that of either of the front or rear legs.

2. The collapsible supporting structure as claimed in claim 1 wherein the arms are foldable.

3. The collapsible supporting structure of claim 2 wherein the arms fold approximately midway along their length.

4. The collapsible supporting structure of claim 2 wherein the arms are pivotable about the mounting body and each arm has a locking arrangement to maintain the arms in the operative and unfolded configuration and a release actuator adapted for simultaneous release of the arms from the operative and unfolded configuration to enable simultaneous pivoting and folding.

5. The collapsible supporting structure of claim 1 wherein there are one or more rear legs and the one or more rear legs and the arms are pivotable about the mounting body.

6. The collapsible supporting structure of claim 5 wherein there are one or more front legs and the one or more front legs are fixed to the mounting body.

7. The collapsible supporting structure of claim 5 wherein there are two rear legs, each mounted to the mounting body by a leg connection arrangement which includes a locking arrangement to secure the rear legs in the operative configuration, wherein the locking arrangements are interconnected for simultaneous release by the operator.

8. The collapsible supporting structure of claim 7 wherein the one or more rear legs are pivotable in a first rotational direction and the arms are pivotable in a second opposite rotational direction.

9. The collapsible supporting structure of claim 5 wherein the mounting body includes a transversely extending mounting bar having a central transverse axis.

10. The collapsible supporting structure of claim 9 wherein the one or more rear legs are mounted for rotation about the mounting body about a first transversely extending axis and the arms are mounted for rotation about the mounting body about a second transversely extending axis, wherein the first and second axes are parallel to each other and offset from the central axis of the mounting bar.

11. A collapsible supporting structure comprising:
a mounting body;
arms extending upwardly from the mounting body; and
front and rear wheeled support legs, wherein at least some of the front and rear legs and arms are pivotally mounted to the mounting body to enable pivoting about the mounting body such that each point on said some of the front and rear legs and arms moves in a fore-aft upright plane between an operative configuration and a collapsed configuration in which the front and rear legs and arms extend substantially coextensively,
wherein the arms are foldable such that in the folded configuration the resultant length of the arms approximates that of either of the front or rear legs.

12. The collapsible supporting structure of claim 11 wherein the arms fold approximately midway along their length.

13. The collapsible supporting structure of claim 12 wherein the arms are pivotable about the mounting body and each arm has a locking arrangement to maintain the arms in the operative and unfolded configuration and a release actuator adapted for simultaneous release of the arms from the operative and unfolded configuration to enable simultaneous pivoting and folding.

14. The collapsible supporting structure of claim 11 wherein there are two rear legs, each mounted to the mounting body by a leg connection arrangement which includes a locking arrangement to secure the rear legs in the operative configuration, wherein the locking arrangements are interconnected for stimultaneous release by the operator.

15. A collapsible supporting structure comprising:
a mounting body;
arms extending upwardly from the mounting body; and
front and rear wheeled support legs, wherein at least some of the front and rear legs and arms are pivotally mounted to the mounting body to enable pivoting about the mounting body about respective transverse axes between an operative configuration and a collapsed configuration in which the front and rear legs and arms extend substantially coextensively,
wherein the arms have an extended configuration for use and a retracted configuration which results in a reduction of the overall length of the arms such that in the retracted configuration, the length of the arms approximates that of either of the front or rear legs.

16. The collapsible supporting structure as claimed in claim 15 wherein the arms are foldable.

17. The collapsible supporting structure of claim 16 wherein the arms fold approximately midway along their length.

18. The collapsible supporting structure of claim 16 wherein the arms are pivotable about the mounting body and each arm has a locking arrangement to maintain the arms in the operative and unfolded configuration and a release actuator adapted for simultaneous release of the arms from the operative and unfolded configuration to enable simultaneous pivoting and folding.

19. The collapsible supporting structure of claim 18 wherein there are two rear legs, each mounted to the mounting body by a leg connection arrangement which includes a locking arrangement to secure the rear legs in the operative configuration, wherein the locking arrangements are interconnected for stimultaneous release by the operator.

20. A collapsible supporting structure comprising:
a mounting body;
arms extending upwardly from the mounting body; and
front and rear wheeled support legs, wherein at least some of the front and rear legs and arms are pivotally mounted to the mounting body to enable pivoting about the mounting body about respective transverse axes between an operative configuration and a collapsed configuration in which,the front and rear legs and arms extend substantially coextensively, wherein the arms are foldable approximately midway along their length.

21. The collapsible supporting structure of claim 20 wherein the arms are pivotable about the mounting body and each arm has a locking arrangement to maintain the arms in the operative and unfolded configuration and a release actuator adapted for simultaneous release of the arms from the operative and unfolded configuration to enable simultaneous pivoting and folding.

22. The collapsible supporting structure of claim 20 wherein there are two rear legs, each mounted to the mounting body by a leg connection arrangement which includes a locking arrangement to secure the rear legs in the operative configuration, wherein the locking arrangements are interconnected for simultaneous release by the operator.
